(19) United States
(12) Patent Application Publication
(10) Pub. No.: US 2025/0087788 A1
(43) Pub. Date: Mar. 13, 2025

(54) ZINC-AIR SECONDARY BATTERY SYSTEM

(71) Applicant: ZINC TECHNOLOGIES., INC., Tokyo (JP)

(72) Inventor: Jae Kyung KONG, Seoul (KR)

(73) Assignee: ZINC TECHNOLOGIES., INC., Tokyo (JP)

(21) Appl. No.: 18/032,242

(22) PCT Filed: Apr. 11, 2023
(86) PCT No.: PCT/JP2023/014678

§ 371 Date: Apr. 17, 2023

(51) Int. Cl. H01M 12/08; H01M 4/62; H01M 50/44; H01M 50/77

(52) U.S. Cl. CPC H01M 12/08; H01M 4/625; H01M 50/44; H01M 50/77

(57) ABSTRACT

A zinc-air secondary battery system of the present invention includes a zinc-air battery array formed by connecting a plurality of zinc-air battery cells each having an air positive electrode part, a separator and a zinc gel negative electrode part containing an electrolyte inside a rectangular case; an external electrolyte tank for storing the electrolyte; and an electrolyte transport part configured to flow the electrolyte from the external electrolyte tank into the zinc gel negative electrode part in each of the zinc-air battery cells so that the electrolyte within the external electrolyte tank and the electrolyte within the zinc gel electrode part are circulated. The external electrolyte tank and the case are provided with gas vent holes. The case is provided with an electrolyte inflow portion that allows the electrolyte from the external electrolyte tank to flow into the zinc gel negative electrode part and an electrolyte outflow portion that allows the electrolyte inside the zinc gel negative electrode part to flow out to the outside, and the electrolyte outflow portion is arranged at a position higher than a position where the electrolyte inflow portion is provided.

### TECHNICAL FIELD

The present invention relates to a zinc-air secondary battery system with an electrolyte and gas flow system.

### RELATED ART

An electrochemical power source is a device in which electric energy can be generated by an electrochemical reaction, and to which a zinc-air secondary battery also corresponds. The zinc-air secondary battery employs a zinc gel negative electrode part made of a zinc gel to be converted into a zinc oxide during discharging and an air positive electrode part having a shape of a layer that is a permeable layer including water molecules and in contact with oxygen present in the air to generate hydroxyl ions. A separation membrane (separator) is arranged between the air positive electrode part and the zinc gel negative electrode part. The separator is a member that prevents an internal short circuit due to direct contact between the air positive electrode part and the zinc gel negative electrode part, and plays an important role not only in the ion passage in the battery but also in improving the safety of the battery.

Such a zinc-air secondary battery has many advantages compared to a hydrogen fuel battery according to the related art. In particular, because a rich fuel such as zinc (Zn) is present as metal or an oxide thereof, the supply of energy supplied from the zinc-air secondary battery is not visibly depleted. Also, hydrogen fuel batteries according to the related art are required to be re-filled, whereas the zinc-air secondary battery can be electrically re-charged and used and can transmit a higher output voltage of 1.4V than general fuel batteries having a voltage of less than 0.8V.

A zinc-air secondary battery generally uses a slurry-type electrolyte in which zinc (Zn), potassium hydroxide (KOH), and water (H2O) are mixed. The electrolyte is contained inside the zinc gel negative electrode part, passes through the separator, impregnates a part of the air positive electrode part, and forms a gas-liquid interface. The zinc-air secondary battery configured as described above operates by transferring electrons generated when zinc contained in the electrolyte reacts with oxygen in the air and changes to zinc oxide.

In the conventional zinc-air secondary battery as described above, a concentration of potassium hydroxide in the electrolyte increases due to consumption of water in the electrolyte during discharge of the zinc-air secondary battery. As a result, there is a problem that the potassium hydroxide is deposited in the air positive electrode part, the air positive electrode part is destroyed and performance of the zinc-air secondary battery is deteriorated. In addition, there is a problem that due to a rapid change in the concentration of the electrolyte, zinc dendrites are formed in the zinc gel negative electrode part and the performance of the zinc-air secondary battery is further deteriorated.

Therefore, there is a need for a system for maintaining optimum electrolyte concentration in such zinc-air secondary batteries.

Further, in the zinc-air secondary battery that is chargeable/dischargeable, as discharging is carried out, Zn of the zinc gel negative electrode part gradually becomes a zinc oxide, and during charging, oxygen present in the zinc oxide is separated and discharged and returns to original zinc. That is, when discharging is sufficiently performed, the higher the oxygen-discharging efficiency of the zinc gel negative electrode part, the higher the charging performance of the zinc-air secondary battery.

Therefore, in order to improve the charging performance of the zinc-air secondary battery, a system is required that supplies oxygen gas to the air positive electrode part during discharging and discharges oxygen gas to an outside of the zinc-air secondary battery during recharging.

### SUMMARY OF INVENTION

### Problem to be Solved by Invention

An object of the present invention is to provide a zinc-air secondary battery system that can maintain an optimum electrolyte concentration, efficiently supply oxygen gas to a zinc-air secondary battery during discharging and efficiently discharge the oxygen gas from the zinc-air secondary battery during recharging.

Such an object is achieved by the present inventions (1) to (7) described below.

(1) A zinc-air secondary battery system comprising:
a zinc-air battery array formed by connecting a plurality of zinc-air battery cells each having an air positive electrode part, a separator and a zinc gel negative electrode part containing an electrolyte inside a rectangular case;
an external electrolyte tank for storing the electrolyte; and
an electrolyte transport part configured to flow the electrolyte from the external electrolyte tank into the zinc gel negative electrode part in each of the zinc-air battery cells so that the electrolyte within the external electrolyte tank and the electrolyte within the zinc gel electrode part are circulated,
wherein the external electrolyte tank and the case are provided with gas vent holes,
wherein the case is provided with an electrolyte inflow portion that allows the electrolyte from the external electrolyte tank to flow into the zinc gel negative electrode part and an electrolyte outflow portion that allows the electrolyte inside the zinc gel negative electrode part to flow out to the outside, and
wherein the electrolyte outflow portion is arranged at a position higher than a position where the electrolyte inflow portion is provided.

(2) The zinc-air secondary battery system described in the above-mentioned item (1), wherein in the two adjacent zinc-air battery cells, the electrolyte outflow portion of one of the zinc-air battery cells and the electrolyte inflow portion of the other zinc-air battery cell are connected to each other.

(3) The zinc-air secondary battery system described in the above-mentioned item (1), wherein the separator is composed of non-woven fibers formed from a polymer solution using an electrospinning method.

(4) The zinc-air secondary battery system described in the above-mentioned item (1), wherein a mixture of Nafion and polyacrylic acid solution is used as the polymer solution, and
wherein the non-woven fibers have sulfur backbone originated from Nafion structure and a rigid structure originated from polyacrylic acid.

(5) The zinc-air secondary battery system described in the above-mentioned item (1), wherein the zinc gel negative electrode part contains an elastic conductive material.

(6) The zinc-air secondary battery system described in the above-mentioned item (1), wherein the elastic conductive material is at least one of expanded graphite and graphene.

(7) The zinc-air secondary battery system described in the above-mentioned item (1), wherein the air positive electrode part includes a slow oxygen transport membrane used when charging the zinc-air battery cell and a fast oxygen transport membrane used when discharging the zinc-air battery cell and having a higher oxygen transport ability than the slow oxygen transport membrane.

### EFFECTS OF INVENTION

According to the present invention, by circulating the electrolyte contained in the zinc gel negative electrode part and the electrolyte in the external electrolyte tank, the concentration of the electrolyte in the zinc-air battery cell, more specifically, the concentration of potassium hydroxide in the electrolyte can be maintained. In particular, in the present invention, the electrolyte outflow portion that allows the electrolyte inside the zinc gel negative electrode part to flow out to the outside is arranged at a position higher than the electrolyte inflow portion that allows the electrolyte from the external electrolyte tank to flow into the zinc gel negative electrode part. Therefore, by activating the electrolyte transport part, the electrolyte having a relatively high concentration of potassium hydroxide accumulated in a lower portion of the zinc gel negative electrode part is allowed to flow out from the electrolyte outflow portion located in an upper portion of the zinc gel negative electrode part. This makes it possible to maintain the concentration of the electrolyte throughout the zinc gel negative electrode part. As a result, it is possible to suppress the deposition of potassium hydroxide in the air positive electrode part and suppress a formation of zinc dendrites in the zinc gel negative electrode part. In addition, oxygen gas can be supplied to the air positive electrode part during discharging and can be discharged to the outside of the zinc-air secondary battery during recharging. As a result, it is possible to provide a zinc-air secondary battery system that has high charging performance and maintains a high output voltage for a long period of time.

### BRIEF DESCRIPTION OF DRAWINGS

FIG. 1 is a schematic diagram showing a preferred embodiment of a zinc-air secondary battery system of the present invention.

FIG. 2 is a schematic diagram showing an internal structure of a zinc-air battery cell included in the zinc-air secondary battery system of FIG. 1.

FIG. 3 is a cross-sectional view of the zinc-air battery cell of FIG. 2.

FIG. 4 is a cross-sectional view schematically showing another configuration example of the zinc-air battery cell included in the zinc-air secondary battery system of the present invention.

### MODE FOR CARRING OUT INVENTION

As the invention allows for various changes and numerous embodiments, particular embodiments will be illustrated in the drawings and described in detail in the written description. However, this is not intended to limit the present invention to particular modes of practice, and it is to be appreciated that all changes, equivalents, and substitutes that do not depart from the spirit and technical scope of the present invention are encompassed in the present invention. In the description of the present invention, certain detailed explanations of related art are omitted when it is deemed that they may unnecessarily obscure the essence of the invention.

The terminology used herein is for the purpose of describing particular embodiments only and is not intended to be limiting to the invention. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, components, and/or groups thereof but do not preclude the presence or addition of one or more other features, integers, steps, operations, elements, components, and/or groups thereof.

While such terms as “first,” “second,” etc., may be used to describe various components, such components must not be limited to the above terms. The above terms are used only to distinguish one component from another.

A zinc-air secondary battery system of the present invention will now be described in detail based on preferred embodiments shown in the accompanying drawings.

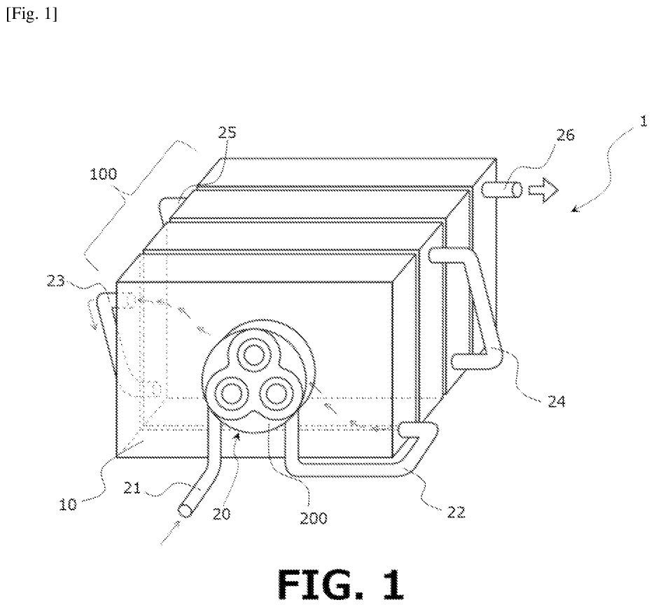

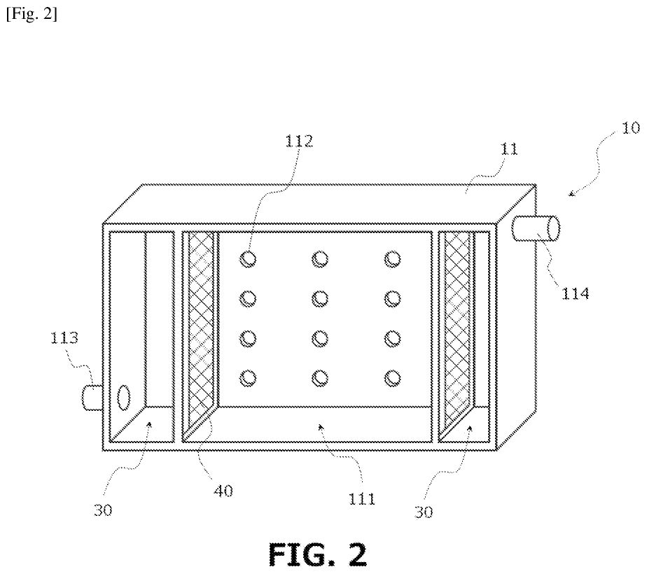

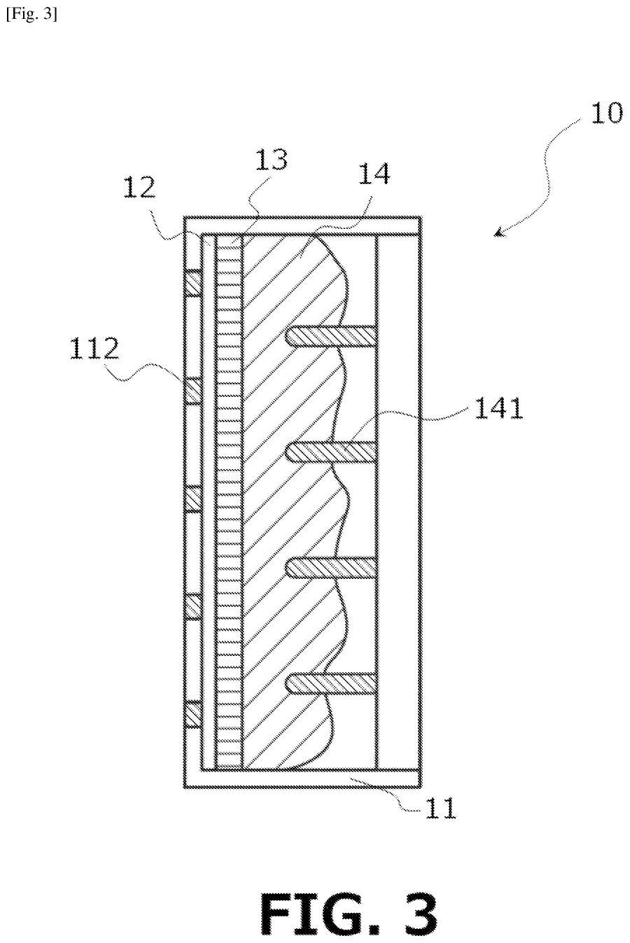

FIG. 1 is a schematic diagram showing a preferred embodiment of a zinc-air secondary battery system of the present invention. FIG. 2 is a schematic diagram showing an internal structure of a zinc-air battery cell included in the zinc-air secondary battery system of FIG. 1. FIG. 3 is a cross-sectional view of the zinc-air battery cell of FIG. 2.

As shown in FIG. 1, the zinc-air secondary battery system 1 of the present embodiment includes a zinc-air battery array 100 formed by connecting a plurality of zinc-air battery cells 10 in series, an external electrolyte tank (not shown), and an electrolyte transport part 20 for circulating an electrolyte in the external electrolyte tank and the electrolyte in each zinc-air battery cell 10.

Prior to detailed description of the zinc-air secondary battery system 1 of the present embodiment, each zinc-air battery cell 10 included in the zinc-air secondary battery system 1 will be described.

### Zinc-Air Battery Cell

As shown in FIGS. 2 and 3, the zinc-air battery cell 10 includes a rectangular case 11, and an air positive electrode part 11, a separator 13 and a zinc gel negative electrode part 14 containing the electrolyte, which are provided in the rectangular case 11.

The case 11 has a rectangular shape and has a cell accommodating portion 111 in a center thereof in which the air positive electrode part 11, the separator 13 and the zinc gel negative electrode part 14 are accommodated. A plurality of gas vent holes 112 for supplying air (oxygen) to the air positive electrode part 11 are formed on a surface of the cell accommodating portion 111 on which the air positive electrode part 11 is arranged.

The case is provided with an electrolyte inflow portion 113 that allows the electrolyte from the external electrolyte tank to flow into the zinc gel negative electrode part 14 and an electrolyte outflow portion 114 that allows the electrolyte inside the zinc gel negative electrode part 14 to flow out to the outside. In this embodiment, the electrolyte inflow portion 113 and the electrolyte outflow portion 114 are arranged symmetrically with respect to the center of the case 11, and the electrolyte outflow portion 114 is arranged at a position higher than the electrolyte inflow portion 113.

Further, auxiliary electrolyte reservoirs 30 are provided on both sides of the cell accommodating portion 111 via grid-like filters 40. Each auxiliary electrolyte reservoir 30 can be filled with a plurality of filters (not shown), and impurities in the electrolyte are filtered through these filters and the grid filter 40.

Further, the case 11 is provided with terminal exposure portions (not shown) for passing a current from the zinc-air battery cell 10 during discharging and for applying a voltage to the zinc-air battery cell 10 during recharging.

The air positive electrode part 112 includes an air diffusion layer, a catalyst active layer, and a positive electrode collector layer, as generally known, and preferably, the air diffusion layer may be formed of a hydrophobic layer material, such as polytetrafluoroethylene (PTFE), so as to extend a life-span of the zinc-air secondary battery by preventing moisture and carbon dioxide (CO2) in the external air from being introduced into the zinc-air secondary battery, and the catalyst active layer is formed of a carbon material that causes a reaction of the following Formula 1 by reacting with introduced oxygen, and preferably, the positive electrode collector layer that collects electrons generated by the chemical reaction of the catalyst active layer may have a mesh structure formed of a conductive material, such as metal.

O₂+2H₂O+4e⁻↔4OH⁻ Formula 1

The separator 13 is interposed between the air positive electrode part 12 and the zinc gel negative electrode part 14 to prevent a short circuit between the air positive electrode part 12 and the zinc gel negative electrode part 14. In addition, the separator 13 also plays a role of transferring hydroxide ions generated by a chemical reaction with oxygen in the catalyst active layer of the air positive electrode part 12 to the zinc gel negative electrode part 14.

As the separator 13, a film formed of a resin material such as polypropylene having ion permeability can be used, but it is preferable that non-woven fibers formed from a polymer solution using an electrospinning method is used.

Membranes traditionally used as separators (e.g., propylene membranes) cannot control selective ion transport and cannot prevent transport of specific ions, such as potassium ions (K⁺) in electrolytes. In contrast, the transport of specific ions such as potassium ions (K⁺) can be prevented by using the separator 13 composed of the non-woven fibers formed from the polymer solution using the electrospinning method.

More specifically, a mixed solution of Nafion and a polyacrylic acid solution is used as the polymer solution to form non-woven fibers by the electrospinning method, and the separator 13 is formed using the non-woven fibers. In this regard, Nafion is a copolymer of tetrafluoroethylene and perfluoro-2-(2-fluorosulfonylethoxy) propylvinyl ether]).

The above non-woven fibers formed by the electrospinning method have sulfur backbone originated from Nafion structure and a rigid structure originated from polyacrylic acid. This sulfur backbone provides a proton (H⁺) transport channel from the zinc gel negative electrode part 14 to the air positive electrode part 11. Since each ion reacts with a hydroxide ion (OH⁻), the potassium ions in the electrolyte are prevented from migrating to the positive electrode part 11. In addition, since the potassium ions are prevented from migrating to the air positive electrode part 11, formation of water, which is advantageous for the stability of the electrolyte concentration, is promoted. As a result, the concentration of the electrolyte is maintained, and the deposition of potassium hydroxide in the air positive electrode part 12 can be suppressed, and the formation of zinc dendrites in the zinc gel negative electrode part 14 can be suppressed.

The prepared separator 13 is attached to the air positive electrode part 12 by bonding, pressing, or thermal lamination to a side of the positive electrode collector layer of the air positive electrode part 12.

The zinc gel negative electrode part 14 that includes a zinc gel having a shape of a gel in which zinc (Zn) and an electrolyte are mixed with each other, causes a reaction of the following Formula 2 and functions as a negative electrode. The electrolyte in the zinc gel negative electrode part 14 is a slurry-type electrolyte in which zinc (Zn), potassium hydroxide (KOH), and water (H₂O) are mixed, and is impregnated in the zinc gel.

Zn+2OH⁻↔Zn(OH)₂+2e⁻

Zn+OH⁻↔ZnO+H₂O+2e⁻ Formula 2

Through the reaction of the above Formula 2, water molecules are generated in the zinc gel negative electrode part 14, and the water molecules generated through the reaction are migrated to the air positive electrode part 12 and are used in the chemical reaction of the above Formula 1.

As shown in FIG. 3, the surface of the case 11 opposite to the surface on which the gas vent holes 112 are formed is provided with a plurality of gel holding pins 141 protruded from the surface. The zinc gel is held by the gel holding pins 141 so as to cover the entire surface of separator 13.

Moreover, the zinc gel of the zinc gel negative electrode part 14 preferably contains an elastic conductive material. Such elastic conductive materials include at least one of expanded graphite and graphene.

The zinc gel negative electrode part 14 changes its volume each time the zinc-air battery cells 10 undergoes recharging and discharging cycles. Due to this phenomenon, the zinc gel negative electrode part 14 aggregates and a specific surface area decreases. When the zinc gel of the zinc gel negative electrode part 14 contains the clastic conductive material, aggregation of the zinc gel negative electrode part 14 is prevented, and the recharging characteristics and discharging characteristics of the zinc-air battery cell 10 can be maintained.

Further, by including the elastic conductive material in the zinc gel, a gap necessary for quicker electrolyte exchange between the electrolyte from the external electrolyte tank and the electrolyte in the zinc gel negative electrode part 14 is formed.

In addition, by including a zinc alloy coil spring with enhanced tension in the zinc gel, the above-mentioned effects can be obtained.

### Air Zinc Secondary Battery System

As described above, the zinc-air secondary battery system 1 of the present embodiment includes a zinc-air battery array 100 formed by connecting the plurality of zinc-air battery cells 10 in series, an external electrolyte tank (not shown), and an electrolyte transport part 20 for circulating an electrolyte in the external electrolyte tank and the electrolyte in each zinc-air battery cell 10.

The zinc-air battery array 100 is formed by connecting four zinc-air battery cells 10 in series, as shown in FIG. 1. In the two adjacent zinc-air battery cells 10, the electrolyte outflow portion 114 of one of the zinc-air battery cells 10 and the electrolyte inflow portion 113 of the other zinc-air battery cell 10 are connected to each other via each liquid feeding tube 23, 24, 25 to be described later. The number of zinc-air battery cells 10 constituting the zinc-air battery array 100 is not limited, and the zinc-air battery array 100 may be composed of a single zinc-air battery cell 10 or may be composed of any number of zinc-air battery cells 10 equal to or greater than two.

The external electrolyte tank has a capacity capable of supplying a sufficient amount of the electrolyte to each zinc-air battery cell 10 and is filled with fresh electrolyte. In addition, the external electrolyte tank is provided with a gas vent hole, and the oxygen gas contained in the electrolyte sent from each zinc-air battery cell 10 of the zinc-air battery array 100 can be discharged through the gas vent hole.

The external electrolyte tank includes an electrolyte outflow portion connected to a liquid feeding tube 21 of the electrolyte transport part 20 and an electrolyte inflow portion connected to a liquid feeding tube 26 for flowing the electrolyte discharged from each zinc-air battery cell 10 of zinc-air battery array 100. By activating the electrolyte transport part 20, the external electrolyte tank sends the fresh electrolyte from the electrolyte outflow portion and collects the electrolyte discharged from each zinc-air battery cell 10 from the electrolyte inflow portion.

The electrolyte transport part 20 is configured to flow the electrolyte from the external electrolyte tank into the zinc gel negative electrode part 14 in each of the zinc-air battery cells so that the electrolyte within the external electrolyte tank and the electrolyte within the zinc gel electrode part 14 are circulated. The electrolyte transport part 20 includes: a liquid feeding pump 200 such as a peristaltic pump; the liquid feeding tube 21 connecting the electrolyte outflow part of the external electrolyte tank and the liquid feeding pump 200; a liquid feeding tube 22 connecting the liquid feeding pump 200 and the electrolyte inflow portion 113 of the first zinc-air battery cell 10 (first from the front in FIG. 1) of the zinc-air battery array 100; the liquid feeding tubes 23, 24, 25 connecting the electrolyte outflow part 114 of one zinc-air battery cell 10 of two adjacent zinc-air battery cells 10 and the electrolyte inflow part 113 of the other zinc-air battery cell 10; and the liquid feeding tube 26 connecting the electrolyte outflow portion 114 of the last zinc-air battery cell 10 (fourth from the front in FIG. 3) of the zinc-air battery array 100 and the electrolyte inflow portion of the external electrolyte tank.

When the liquid feed pump 200 is activated, the fresh electrolyte flows from the external electrolyte tank through the liquid feeding tubes 21 and 22 into the electrolyte inflow portion 113 of the first zinc-air battery cell 10. Subsequently, the electrolyte in the first zinc-air battery cell 10 and the fresh electrolyte from the external electrolytic solution tank are discharged from the electrolyte outflow portion 114 and flows into the electrolyte inflow portion 113 of the second zinc-air battery cell 10 via the liquid feeding tube 23. In this manner, the electrolyte in each zinc-air battery cell 10 is replaced with the fresh electrolyte from the external electrolyte tank and discharged from the electrolyte outflow portion 114 of the last zinc-air battery cell 10. The discharged electrolyte in each zinc-air battery cell 10 is sent to the external electrolyte tank via the liquid feeding tube 26.

In the present embodiment, the concentration of the electrolyte in each zinc-air battery cell 10, more specifically, the concentration of the potassium hydroxide in the electrolyte can be maintained.

In particular, in the present invention, the electrolyte outflow portion 114 of each zinc-air battery cell 10 is arranged at a position higher than the electrolyte inflow portion 113 of each zinc-air battery cell 10. Therefore, by activating the liquid feeding pump 200, the electrolyte having a relatively high concentration of the potassium hydroxide accumulated in a lower portion of the zinc gel negative electrode part 14 is allowed to flow out from the electrolyte outflow portion 113 located in an upper portion of the zinc gel negative electrode part 14. This makes it possible to maintain the concentration of the electrolyte throughout the zinc gel negative electrode part 14. As a result, it is possible to suppress the deposition of potassium hydroxide in the air positive electrode part 12 and suppress the formation of zinc dendrites in the zinc gel negative electrode part 14.

In addition, oxygen gas can be supplied to the air positive electrode part 12 during discharging and can be discharged to the outside of the zinc-air secondary battery together with the electrolyte during recharging.

Due to the above effects, in the zinc-air secondary battery system 1 of the present embodiment, each zinc-air battery cell 10 can have high charging performance and maintain a high output voltage for a long period of time.

In the above-described zinc-air secondary battery system 1 of the present embodiment, the electrolyte in the external electrolyte tank and the electrolyte in the zinc-air battery cell 10 are circulated using the liquid feeding pump 200, but not limited to this configuration. For example, the electrolyte in the external electrolyte tank and the electrolyte in the zinc-air battery cell 10 may be circulated using the concentration difference of the electrolyte.

Further, the liquid sending pump 200 may be provided for each zinc-air battery cell 10. Furthermore, it is also possible to circulate the electrolyte between the external electrolyte tank and each zinc-air battery cell 10.

In the zinc-air battery cell shown in FIG. 3, one air positive electrode part 12 is arranged on one side of the zinc gel negative electrode part 14, but a configuration described below may be adopted.

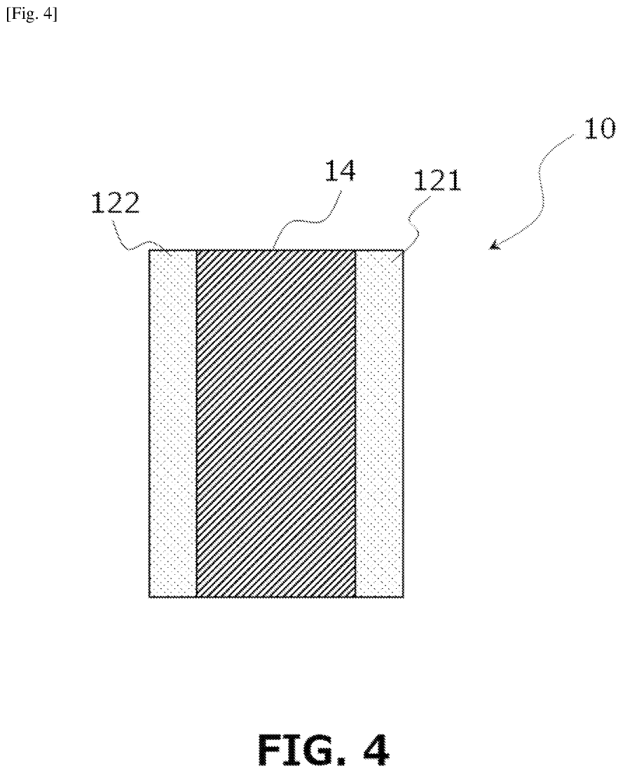

FIG. 4 is a cross-sectional view schematically showing another configuration example of the zinc-air battery cell included in the zinc-air secondary battery system of the present invention.

In the zinc-air battery cell 10 shown in FIG. 4, a slow oxygen transport membrane 121 used when charging the zinc-air battery cell 10 is arranged on one side of the zinc gel negative electrode part 14 via the separator (not shown). On the other side of the zinc gel negative electrode portion 14, a fast oxygen transport membrane 122 used when discharging the zinc-air battery cell 10 and having a higher oxygen transport ability than the slow oxygen transport membrane 121 is arranged via the separator (not shown). In this regard, the fast oxygen transport membrane 122 is arranged on the side of the case 11 on which the gas vent holes 112 are formed.

The fast oxygen transport membrane 122 has a higher oxygen transport rate than the slow oxygen transport membrane 121. In the charging reaction of the zinc-air battery cell 10, oxygen gas is produced from ZnO. This oxygen gas increases an internal pressure of the zinc-air battery cell 10 and slows down the reaction rate during charging. In the configuration of FIG. 4, the voltage is applied between the slow oxygen transport membrane 121 and the zinc gel negative electrode part 14 when charging the zinc-air battery cell 10. As a result, a supply of the oxygen gas through the slow oxygen transport membrane 121 is suppressed, and the oxygen gas can be efficiently discharged to the outside of the zinc-air battery cell 10 together with the electrolyte due to the action of the electrolyte transport part 20.

On the other hand, in the configuration of FIG. 4, the voltage is applied between the fast oxygen transport membrane 122 and the zinc gel negative electrode part 14 when discharging the zinc-air battery cell 10. This makes it possible to supply the oxygen gas efficiently through the fast oxygen transport membrane 122, and the reaction rate during discharge is increased. As a result, the zinc-air secondary battery system 1 having a high output voltage can be obtained.

While the invention has been shown and described with reference to certain exemplary embodiments thereof, it will be understood by those skilled in the art that various changes in form and details may be made therein without departing from the spirit and scope of the invention as defined by the appended claims.

### Industrial Applicability

According to the present invention, by circulating the electrolyte contained in the zinc gel negative electrode part and the electrolyte in the external electrolyte tank, the concentration of the electrolyte in the zinc-air battery cell, more specifically, the concentration of potassium hydroxide in the electrolyte can be maintained. In particular, in the present invention, the electrolyte outflow portion that allows the electrolyte inside the zinc gel negative electrode part to flow out to the outside is arranged at a position higher than the electrolyte inflow portion that allows the electrolyte from the external electrolyte tank to flow into the zinc gel negative electrode part. Therefore, by activating the electrolyte transport part, the electrolyte having a relatively high concentration of potassium hydroxide accumulated in a lower portion of the zinc gel negative electrode part is allowed to flow out from the electrolyte outflow portion located in an upper portion of the zinc gel negative electrode part. This makes it possible to maintain the concentration of the electrolyte throughout the zinc gel negative electrode part. As a result, it is possible to suppress the deposition of potassium hydroxide in the air positive electrode part and suppress a formation of zinc dendrites in the zinc gel negative electrode part. In addition, oxygen gas can be supplied to the air positive electrode part during discharging and can be discharged to the outside of the zinc-air secondary battery during recharging. As a result, it is possible to provide a zinc-air secondary battery system that has high charging performance and maintains a high output voltage for a long period of time. Therefore, the present invention has industrial applicability.

1. A zinc-air secondary battery system comprising:
a zinc-air battery array formed by connecting a plurality of zinc-air battery cells each having an air positive electrode part, a separator and a zinc gel negative electrode part containing an electrolyte inside a rectangular case;
an external electrolyte tank for storing the electrolyte; and
an electrolyte transport part configured to flow the electrolyte from the external electrolyte tank into the zinc gel negative electrode part in each of the zinc-air battery cells so that the electrolyte within the external electrolyte tank and the electrolyte within the zinc gel electrode part are circulated,
wherein the external electrolyte tank and the case are provided with gas vent holes,
wherein the case is provided with an electrolyte inflow portion that allows the electrolyte from the external electrolyte tank to flow into the zinc gel negative electrode part and an electrolyte outflow portion that allows the electrolyte inside the zinc gel negative electrode part to flow out to the outside, and
wherein the electrolyte outflow portion is arranged at a position higher than a position where the electrolyte inflow portion is provided.

2. The zinc-air secondary battery system as claimed in claim 1, wherein in the two adjacent zinc-air battery cells, the electrolyte outflow portion of one of the zinc-air battery cells and the electrolyte inflow portion of the other zinc-air battery cell are connected to each other.

3. The zinc-air secondary battery system as claimed in claim 1, wherein the separator is composed of non-woven fibers formed from a polymer solution using an electrospinning method.

4. The zinc-air secondary battery system as claimed in claim 1, wherein a mixture of Nafion and polyacrylic acid solution is used as the polymer solution, and
wherein the non-woven fibers have sulfur backbone originated from Nation structure and a rigid structure originated from polyacrylic acid.

5. The zinc-air secondary battery system as claimed in claim 1, wherein the zinc gel negative electrode part contains an elastic conductive material.

6. The zinc-air secondary battery system as claimed in claim 1, wherein the elastic conductive material is at least one of expanded graphite and graphene.

7. The zinc-air secondary battery system as claimed in claim 1, wherein the air positive electrode part includes a slow oxygen transport membrane used when charging the zinc-air battery cell and a fast oxygen transport membrane used when discharging the zinc-air battery cell and having a higher oxygen transport ability than the slow oxygen transport membrane.
